(19) United States
(12) Patent Application Publication
(10) Pub. No.: US 2009/0160335 A1
(43) Pub. Date: Jun. 25, 2009

(54) Plasma display panel and manufacturing method of the same

(76) Inventors: Byoung-Min Chun, Suwon-si (KR); Eui-Jeong Hwang, Suwon-si (KR); Yong-Mi Yu, Suwon-si (KR); Seong-Gi Choo, Suwon-si (KR); Hyea-Weon Shin, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/318,231

(22) Filed: Dec. 23, 2008

(30) Foreign Application Priority Data
Dec. 24, 2007 (KR) 10-2007-0136507

(51) Int. Cl. H01J 17/49; H01J 9/26

(52) U.S. Cl. 313/582; 445/25

(57) ABSTRACT

A PDP includes a first substrate and a second substrate overlapping each other, the first and second substrates being sealed to each other along a sealing line, the sealing line being in peripheral portions of the first and second substrates, a metal layer along the sealing line on at least one of the first and second substrates, the metal layer being between the first and second substrates, and a frit layer on the metal layer.

### BACKGROUND OF THE INVENTION

1. Field of the Invention

Example embodiments relate to a plasma display panel (PDP) and to a manufacturing method thereof. More particularly, example embodiments relate to a PDP structure configured to minimize deformation of substrates and of internal elements during the manufacturing method thereof.

2. Description of the Related Art

Generally, a PDP refers to a display device displaying images by generating a plasma discharge, so phosphors may be excited by vacuum ultraviolet (VUV) rays generated during the plasma discharge to emit visible light and to form images. A conventional PDP may include electrodes between two substrates, so application of voltage to the electrodes in presence of a discharge gas may trigger the plasma discharge.

The two substrates of the PDP may be sealed together with the electrodes therebetween. However, a conventional sealing process may include subjecting the entire area of the PFP to a high-temperature process, thereby causing heat application to, e.g., substrates and/or internal elements of the PDP. When the entire PDP is heated during the conventional sealing process, the substrates and the electrodes may deform.

The above information disclosed in this Background section is only for enhancement of understanding of the background of the invention and therefore it may contain information that does not form the prior art that is already known in this country to a person of ordinary skill in the art.

### SUMMARY OF THE INVENTION

Example embodiments are therefore directed to a PDP and to a manufacturing method thereof, which substantially overcome one or more of the disadvantages of the related art.

It is therefore a feature of an example embodiment to provide a PDP having a structure capable of minimizing deformation of substrates and internal elements thereof during substrate sealing.

It is another feature of an example embodiment to provide a method of manufacturing a PDP having a structure capable of minimizing deformation of substrates and internal elements thereof during substrate sealing.

At least one of the above and other features and advantages may be realized by providing a PDP, including a first substrate and a second substrate overlapping each other, the first and second substrates being sealed with each other along a sealing line, the sealing line being in peripheral portions of the first and second substrates, a metal layer along the sealing line on at least one of the first and second substrates, the metal layer being between the first and second substrates, and a frit layer on the metal layer.

The PDP may further include a protective layer along the sealing line on at least one of the first and second substrates, the protective layer being between the metal layer and a corresponding substrate. The protective layer may have a band shape with a predetermined width along the sealing line. The metal layer may have a band shape with a predetermined width along the sealing line. The frit layer may have a band shape with a predetermined width along the metal layer. The protective layer may include a heat insulating material and/or a shock absorbing material. The protective layer may include a first protective layer on an inner surface of the first substrate and a second protective layer on an inner surface of the second substrate, the first and second protective layers facing each other. The metal layer may include a first metal layer on the first protective layer and a second metal layer on the second protective layer, the first and second metal layers facing each other. The frit layer may be between the first and second metal layers. The PDP may further include a plurality of electrodes between the first and second substrates, the electrodes including connection units extending through the frit layer, the connection units being surrounded by the frit layer on the sealing line and eclectically isolated from the metal layer. A portion of the connection unit in the frit layer may include a conductive unit surrounded by a dielectric layer.

At least one of the above and other features and advantages may be realized by providing a PDP manufacturing method, including forming a first substrate and a second substrate to overlap each other and to seal with each other along a sealing line, the sealing line being in peripheral portions of the first and second substrates, forming a metal layer along the sealing line on at least one of the first and second substrates, the metal layer being between the first and second substrates, and forming a frit layer on the metal layer.

The PDP manufacturing method may further include inducing current in the metal layer using an inductor disposed proximate to the PDP, such that the metal layer is heated, and pressing the first and second substrates toward each other, such that the first and second substrates are sealed together via the frit layer. The PDP manufacturing method may further include forming a protective layer along the sealing line on at least one of the first and second substrates, the protective layer being between the metal layer and a corresponding substrate. The protective layer may be formed in a band shape having a predetermined width along the sealing line. The metal layer may be formed in a band shape having a predetermined width along the protective layer. The frit layer may be formed in a band shape having a predetermined width along the metal layer. Forming the protective may include forming a first protective layer on an inner surface of the first substrate and a second protective layer on an inner surface of the second substrate, such that the first and second protective layers face each other. Forming the metal layer may include forming a first metal layer on the first protective layer and a second metal layer on the second protective layer, the first and second metal layers facing each other. Forming the frit layer may include forming a first frit layer on the first metal layer and a second frit layer on the second metal layer, the first and second frit layers facing each other.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a PDP according to an example embodiment;

FIG. 2 illustrates a cross-sectional view along line II-II of FIG. 1;

FIG. 3 illustrates a cross-sectional view along line III-III of FIG. 1;

FIG. 4 illustrates a perspective view of electrodes in the PDP of FIG. 1;

FIG. 5 illustrates a perspective view of a schematic configuration of a PDP and alignment of an induced current generator in a method of manufacturing a PDP according to an example embodiment;

FIG. 6 illustrates a perspective view of a process for forming a protective layer in a PDP according to an example embodiment;

FIG. 7 illustrates a perspective view of a process for forming a metal layer on the protective layer of FIG. 6;

FIG. 8 illustrates a perspective view of a process for forming a frit layer on the metal layer of FIG. 7;

FIG. 9 illustrates a cross-sectional view along line IX-IX of FIG. 5 of an alignment process of two substrates formed according to the process of FIG. 8; and

FIG. 10 illustrates a cross-sectional view of a process for sealing the two substrates of FIG. 9.

### DETAILED DESCRIPTION OF THE INVENTION

Korean Patent Application No. 10-2007-0136507, filed on Dec. 24, 2007, in the Korean Intellectual Property Office, and entitled: “Plasma Display Panel and Manufacturing Method of the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “a” and “an” are open terms that may be used in conjunction with singular items or with plural items.

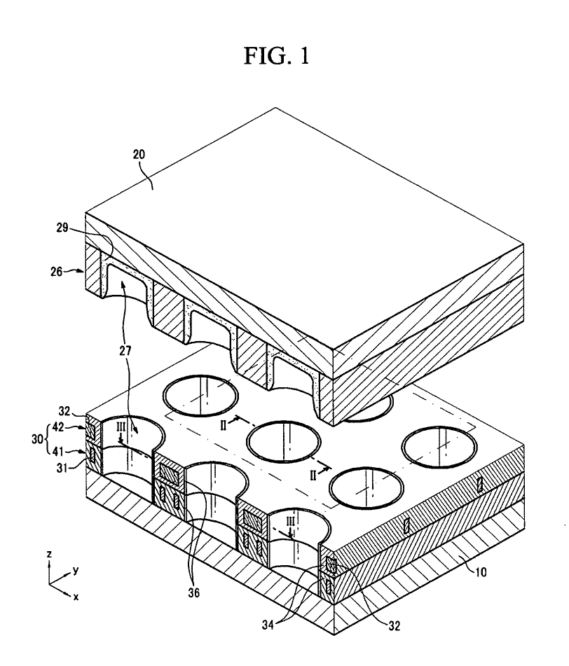

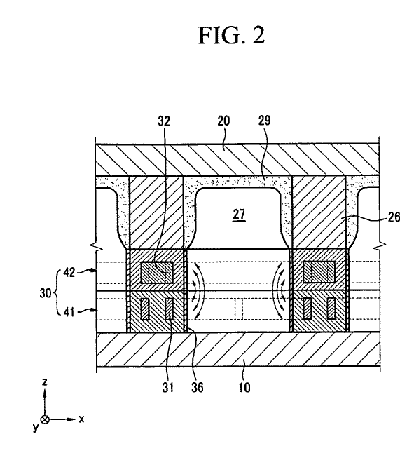

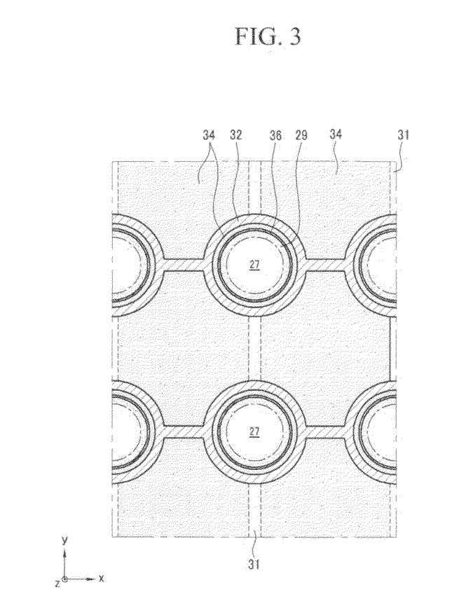

A PDP according to example embodiments will be described in more detail below with reference to FIGS. 1-3. FIG. 1 illustrates an exploded perspective view of a PDP according to an example embodiment. FIG. 2 illustrates a cross-sectional view of FIG. 1 taken along line II-II. FIG. 3 illustrates a cross-sectional view of FIG. 1 taken along line III-III.

Referring to FIGS. 1-2, a PDP, e.g., a two-electrode type PDP, may include a first substrate 10, a second substrate 20, a barrier rib layer 26 defining discharge cells 27, and an electrode layer 30. The PDP may include a display area, i.e., an area displaying images, e.g., including the discharge cells 27, and a non-display area, i.e., an area peripheral to the display area displaying images.

The first and second substrates 10 and 20 may face each other with a predetermined distance therebetween, and the barrier rib layer 26 and the electrode layer 30 may be interposed between the first and second substrates 10 and 20. The first and second substrates 10 and 20 may overlap each other, e.g., partially cross each other, to define an overlapped area therebetween. Both the display area and non-display area of the PDP may be within the overlapped area of the first and second substrates 10 and 20. For example, the first substrate 10 may be a front substrate, and the second substrate 20 may be a rear substrate.

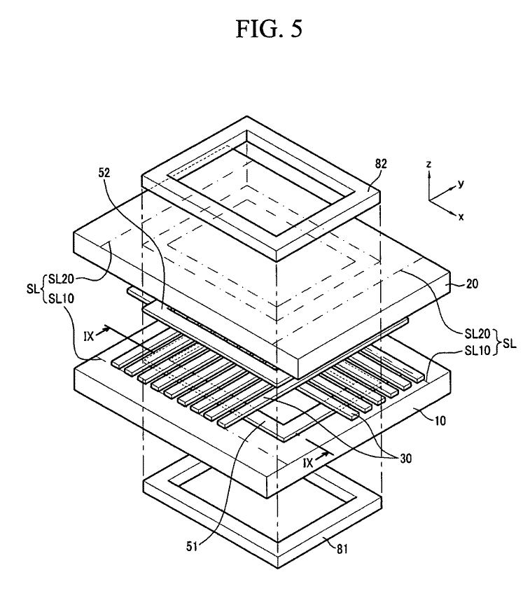

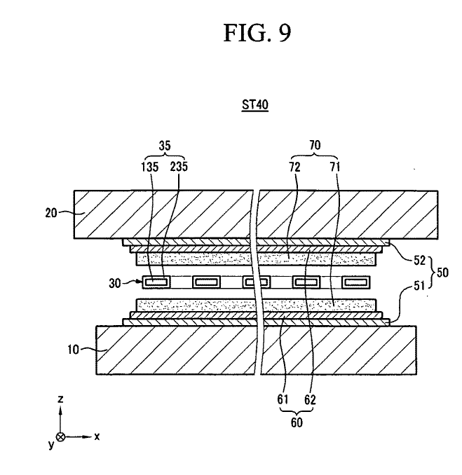

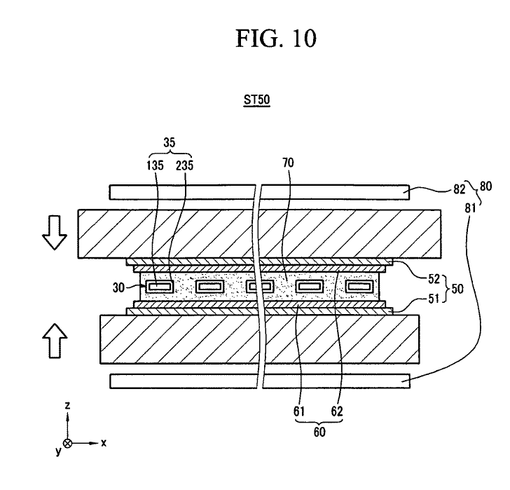

The first and second substrates 10 and 20 may be attached to each other via a frit layer (frit layer 70 in FIGS. 9-10) to form a sealed overlapped area therebetween, i.e., the first and second substrate 10 and 20 may be sealed to each other. To facilitate sealing, the PDP may include a protective layer, a frit layer, and a metal layer between the first and second substrate 10 and 20. It is noted, however, that for clarity, the protective layer, frit layer, and metal layer will be described in detail below with respect to a manufacturing method of the PDP and the corresponding figures, i.e., FIGS. 5-10.

As illustrated in FIGS. 1-2, the barrier rib layer 26 may be disposed between the first substrate 10 and the second substrate 20, and may define a plurality of the discharge cells 27 between the first and second substrate 10 and 20 by partitioning the sealed space between the first and second substrates 10 and 20. For example, as illustrated in FIGS. 1-2, the barrier rib layer 26 may be formed on the second substrate 20. Other configurations of the barrier rib layer 26, e.g., the barrier rib layer 26 may be formed on the first substrate 10, the barrier rib layer 26 may be formed on both the first and second substrates 10 and 20, and so forth, are within the scope of the present invention.

As illustrated in FIGS. 1-2, the discharge cells 27 may be formed in the barrier rib layers 26, e.g., through the barrier layers 26, and in the electrode layer 30. For example, a first portion of the discharge cells 27, e.g., a portion adjacent to the second substrate 20, may be defined by the barrier rib layer 26, and a second portion of the discharge cells 27, e.g., a portion adjacent to the first substrate 10, may be defined by the electrode layer 30. The discharge cells 27 may be separately formed from the second substrate 20, as illustrated in FIGS. 1-2. Other configurations of the discharge cells 27, e.g., the discharge cells 27 may be integrally formed with the first and second substrates 10 and 20 by etching the first substrate 10 or the second substrate 20 (not shown), are within the scope of the present invention. The PDP may include millions or more discharge cells 27 arranged, e.g., in a matrix format.

The discharge cells 27 may have any suitable shape. For example, as illustrated in FIGS. I and 3, the discharge cells 27 may have a cylindrical shape. The cylindrical discharge cells 27 may maintain a constant distance between an interior circumference and the center thereof. Other configurations of the discharge cells 27, e.g., the discharge cells 27 may have a cross-section of, e.g., a quadrangle or a hexagon, are within the scope of the present invention.

A phosphor layer 29 may be formed in the discharge cells 27, as illustrated in FIGS. 1-3. For example, the phosphor layer 29 may be formed on inner sidewalls of the discharge cell 27, i.e., on sidewalls defined by the barrier rib layer 26, and on an inner surface of the second substrate 20, i.e., a surface facing the first substrate 10. Other configurations of the phosphor layer 29, e.g., the phosphor layer 29 may be formed on the first substrate 10 or the phosphor layer 29 may be formed on both the first and second substrates 10 and 20, are within the scope of the present invention.

It is noted that if the phosphor layer 29 is on a front substrate, the phosphor layer 29 may be formed of a transmissive phosphor that absorbs VUV rays inside the discharge cell 27 and transmits visible light to the first substrate 10, e.g., visible rays of red R, green G, and/or blue B light, when the phosphor layer 29 is stabilized. If the phosphor layer 29 is on a rear substrate, the phosphor layer 29 may be formed of a reflective phosphor that reflects visible light from inside the discharge cell 27 to the front substrate.

A discharge gas, e.g., one or more of neon (Ne) gas and xenon (Xe) gas, may be filled inside the discharge cell 27 to facilitate generation of plasma discharge and VUV rays. The discharge gas may be filled in the discharge cells 27 after sealing the first and second substrates 10 and 20 and removing residue gas from the sealed space between the first and second substrates 10 and 20.

As illustrated in FIGS. 1-2, the electrode layer 30 may include a first electrode 31 and a second electrode 32 between the first and second substrates 10 and 20. For example, as illustrated in FIGS. 1-2, the electrodes layer 30 may be on the first substrate 10, so the electrode layer 30 may be between the first substrate 10 and the barrier rib layer 26. In another example, the barrier rib layer 26 may be formed on the first substrate 10, and the electrode layer 30 may be formed on the second substrate 20. In yet another example, first and second barrier rib layers may be formed on respective first and second substrates 10, and the electrode layer 30 may be interposed between the first and second substrates 10 and 20 in any suitable configuration with respect to the first and second barrier layers. The first and second electrodes 31 and 32 may be arranged to correspond to each of the discharge cells 27, i.e., the discharge cells 27 may be formed at intersections of the first and second electrodes 31 and 32. For example, the first and second electrodes 31 and 32 may be positioned in the display area of the PDP, so edges of the first and second electrodes 31 and 32 may extend from the display area to the non-display area to define connection unit 35 in the non-display area, as illustrated in FIGS. 9-10.

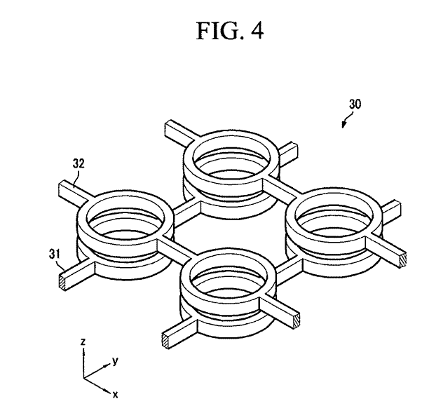

FIG. 4 illustrates a perspective view of only the first and second electrodes 31 and 32 in the PDP of FIG. 1.

Referring to FIG. 4, the first electrode 31 may be formed in a structure that surrounds the discharge cell 27. In particular, each electrode 31 may include a shaped-portion, e.g., a circular portion, surrounding a corresponding discharge cell 27 and a linear portion connecting two adjacent shaped-portions along a first direction, e.g., along the y-axis. The first electrodes 31, i.e., the linear portions of the first electrodes 31, may extend along the first direction, and may be spaced apart from each other along a second direction, e.g., along the x-axis. That is, a plurality of the first electrodes 31 may be disposed in parallel to each other at a predetermined distance that is set to correspond to a distance between adjacent discharge cells 27 along the second direction. The first and second directions may cross.

As illustrated in FIG. 4, the second electrode 32 may be formed in a structure that faces the first electrode 31 and surrounds the discharge cell 27. The second electrodes 32 may have a substantially same structure as the first electrodes 31, and may extend along the second direction to cross the first electrodes 31. That is, a plurality of second electrodes 32 may be disposed in parallel with each other having a predetermined distance therebetween along the y-axis so as to respectively correspond to the discharge cells 27 that are adjacent to each other. Respective shaped-portions of the first and second electrodes 31 and 32 may completely overlap each other to correspond to and surround the discharge cells 27.

As further illustrated in FIG. 4, the first electrode 31 and the second electrode 32 may be separated from each other in the electrode layer 30 along a third direction, e.g., along the z-axis, that may be perpendicular to a plane defined by the first and second direction. For example, the first electrode 31 may surround a portion of the discharge cell 27 adjacent to the first substrate 10, and the second electrode 32 may surround a portion of the discharge cell 27 adjacent to the second substrate 20. Since the first and second electrodes 31 and 32 have portions surrounding the discharge cells 27, the first and second electrodes 31 and 32 may not block visible light emitted from the discharge cell 27, e.g., toward a front substrate along the third direction. Further, a front aperture ratio of the discharge in the discharge cells 27 may be improved, so the discharge may be focused toward centers of respective discharge cells 27.

Since the first and second electrodes 31 and 32 are formed around the discharge cells 27, the first electrode 31 and the second electrode 32 may be formed of an opaque metal material having excellent electrical conductivity. The electrode layer 30 may be formed by anodizing the first electrode 31 and the second electrode 32. For example, the electrode layer 30 may be formed by forming the first electrode 31 and the second electrode 32 of, e.g., aluminum (Al). In particular, the electrode layer 30 may be formed of a first electrode layer 41, i.e., a layer including the first electrodes 31 embedded in a dielectric layer 34, and a second electrode layer 42, i.e., a layer including the second electrodes 32 embedded in the dielectric layer 34. For example, the first and second electrode layers 41 and 42 may be separately formed and stacked, e.g., each of the first and second electrode layers 41 and 42 may be formed in a sheet state. In another example, the first and second electrode layers 41 and 42 may be formed integrally, e.g., in a sheet state. The first electrode layer 41 may be formed by anodizing the first electrode 31, and the second electrode layer 42 may be formed by anodizing the second electrode 32.

Referring back to FIGS. 1-2, the electrode layer 30 may include the dielectric layer 34. The dielectric layer 34 may surround, e.g., completely surround, each of the first and second electrodes 31 and 32, so the first and second electrodes 31 and 32 may be insulated from each other. As illustrated in FIGS. 1 and 3, the dielectric layer 34 may define the second portion of the discharge cell 27 in, e.g., a cylindrical shape, corresponding to a shape of the first and second electrodes 31 and 32. Therefore, the discharge cell 27 may be defined by the barrier rib layer 26 on the second substrate 20, and may be defined by the dielectric layer 34 on the first substrate 10. The discharge cells 27 may be on both the first and second substrates 20 and 10 and, e.g., may be connected to each other.

The dielectric layer 34 may provide a space for forming and accumulating wall charges when a discharge occurs. In particular, since the dielectric layer 34 covers the first and second electrodes 31 and 32, the dielectric layer may form and accumulate wall charges according to a voltage signal applied to the first and second electrodes 31 and 32. Therefore, the dielectric layer 34 may enable realization of an address discharge for selecting discharge cell 27 to be turned on among a plurality of discharge cells 27 and a sustain discharge for displaying an image with the selected discharge cell 27 with a low voltage. The dielectric layer 34 may be formed, e.g., of aluminum oxide (Al₂O₃). For example, the dielectric layer 34 may be formed by forming aluminum oxide (Al₂O₃) from an anodizing process on the first and second electrodes 31 and 32.

As illustrated in FIGS. 1-3, the PDP may further include a protection layer 36 on an inner surface of the discharge cell 27, i.e., on the dielectric layer 34 of the electrode layer 30. For example, as illustrated in FIG. 2, the protection layer 36 may be perpendicular to the first and second substrates 10 and 20. The protection layer 36 may protect the dielectric layer 34 from the discharge in the discharge cells 27, and may exhibit a high secondary electron emission coefficient.

Since the protection layer 36 is formed in sidewalls of the discharge cell 27, the protection layer 36 may be made of a non-transparent material, e.g., a non-transparent magnesium oxide (MgO). In this respect, it is noted that the non-transparent MgO may exhibit a much higher secondary electron emission coefficient as compared to a transparent MgO. Therefore, a discharge firing voltage of a PDP having a non-transparent MgO protection layer may be lower than that of a PDP having a transparent MgO protection layer.

The PDP may be driven as follows. An address discharge may be generated between the first and second electrodes 31 and 32 by an address pulse applied to the first electrode 31 and a scan pulse applied to the second electrode 32. Accordingly, a discharge cell 27 to be turned on may be selected by the address discharge.

While maintaining the first electrode 31 at a reference voltage of about 0 V, a positive (+) sustain voltage pulse and a negative (−) sustain voltage pulse may be alternately applied to the second electrode 32, so that a sustain discharge may be generated between the two electrodes 31 and 32. Accordingly, the sustain discharge may drive the selected discharge cells 27 to display an image. The first electrode 31 and the second electrode 32 may have different functions according to a signal voltage applied thereto, and therefore, relationships between the first and second electrodes 31 and 32 and the signal voltage may not be limited to the above description.

It is noted that even though FIGS. 1-4 illustrate a PDP of a two-electrode structure, other PDP types, e.g., a PDP of a three-electrode structure, are within the scope of the present invention. For example, a PDP of a three-electrode structure may include address electrodes on a first substrate and pairs of sustain/scan electrodes on a second substrate crossing the address electrodes, such that intersection regions of the address electrodes with the sustain and scan electrodes may define discharge cells, e.g., millions or more discharge cells arranged in a matrix format.

According to another example embodiment, a method of manufacturing a PDP will be explained in more detail below with reference to the accompanying figures.

The electrode layer 30 and the barrier rib layer 26 may be formed on respective first and second substrate 10 and 20 according to any suitable method. Next, the first and second substrates 10 and 20 may be sealed, such that the electrode layer 30 and the barrier rib layer 26 may be arranged to contact each other between the first and second substrates 10 and 20. For example, the first and second substrates 10 and 20 may be sealed after interposing a separately manufactured electrode layer 30 therebetween, e.g., the electrode layer 30 may be manufactured as an integral unit of first and second electrodes 31 and 32. In another example, the first and second substrates 10 and 20 may be sealed after interposing separately manufactured first and second electrode layers 41 and 42 therebetween, e.g., each of the first electrode layer 41 and second electrode layer 42 may be manufactured separately and interposed to overlap the first and second substrates 10 and 20.

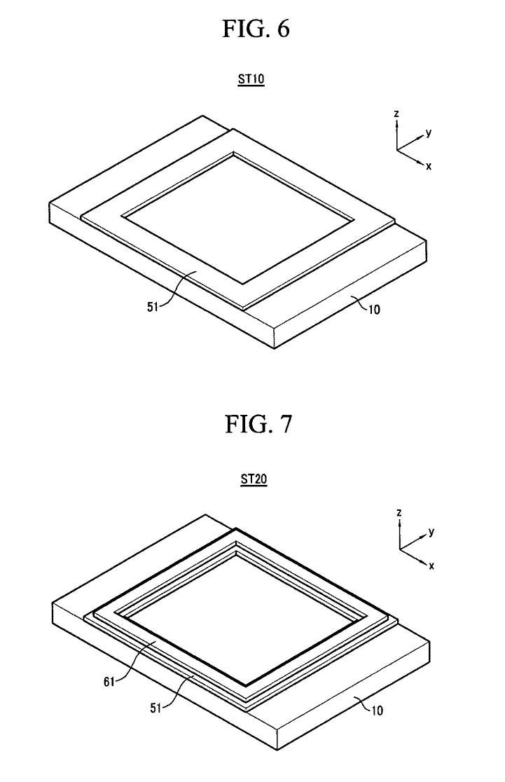

A detailed description of a process of sealing the first and second substrates 10 and 20 will described in more detail below with reference to FIGS. 5-10. FIG. 5 illustrates a schematic perspective configuration of a PDP and alignment of an induced current generator therein with respect to a sealing line in the PDP. FIGS. 6-8 and 9-10 illustrate schematic perspective and cross-sectional views, respectively, of sequential stages in sealing the first and second substrates 10 and 20 of the PDP in FIG. 5. FIGS. 9-10 illustrate schematic cross-sectional views along line IX-IX of FIG. 5. It is noted that for ease of description FIGS. 6-10 illustrate schematic view of peripheral structures in the PDP, while omitting the detailed structures of the internal elements in the display area of the PDP. The internal elements of the PDP of FIG. 5, e.g., elements in the display area of the PDP, may correspond to the elements described previously with reference to FIGS. 1-4.

Referring to FIG. 5, the first and second substrates 10 and 20 may be disposed to overlap and cross with each other, such that the electrode layer 30 may be therebetween. As further illustrated in FIG. 5, a sealing line SL may be formed along outer edges of the overlapping area of the first and second substrates 10 and 20. The first substrate 10 and the second substrate 20 may be sealed along the sealing line SL.

The sealing line SL may include a first sealing line SL10 and a second sealing line SL20 along respective long and short sides of the PDP. For example, the first sealing line SL10 may be formed along longer sides of the first substrate 10 to face longer sides of the second substrate 20, and a second sealing line SL20 may be formed along shorter sides of the first substrate 10 to face shorter sides of the second substrate 20.

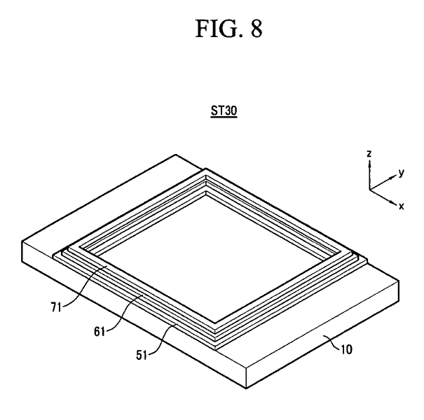

The PDP manufacturing method according to an example embodiment may include a protective layer forming process, i.e., ST10 in FIG. 6, a metal layer forming process, i.e., ST20 in FIG. 7, a frit layer forming process, i.e., ST30 in FIG. 8, an alignment process, i.e., ST40 in FIG. 9, and a heating/sealing process, i.e., ST50 in FIG. 10. The protective layer forming process ST10 may form a first protective layer 51 on, e.g., the first substrate 10, in a position corresponding to the sealing line SL, as illustrated in FIG. 6. The metal layer forming process ST20 may form a first metal layer 61 on the first protective layer 51, as illustrated in FIG. 7. The frit layer forming process ST30 may form a first frit layer 71 on the first metal layer 61, as illustrated in FIG. 8. It is noted that even though FIGS. 6-8 illustrate only formation of first protective, metal and frit layers 51, 61, and 71, respectively, on the first substrate 10, the PDP manufacturing process may include formation of second protective, metal and frit layers 52, 62, and 72, respectively, on the second substrate 20, as illustrated in FIGS. 9-10, via a substantially same method as the first protective, metal and frit layers 51, 61, and 71 described with reference to FIGS. 6-8.

The alignment process ST40 may align the first and second substrates 10 and 20 to face each other. The heating/sealing process ST50 may heat, e.g., the first metal layer 61, via an induced current to melt, e.g., the first frit layer 71, so the first and second substrates 10 and 20 may be pressed to each other via, e.g., the first frit layer 71, to form a seal therebetween, as illustrated in FIG. 10. It is further noted that for convenience, first and second protective layers 51 and 52 may be referred to as a protective layer 50, first and second metal layers 61 and 62 may be referred to as a metal layer 60, and first and second frit layers 71 and 72 may be referred to as a frit layer 70. The metal layer 60 may be formed by silver (Ag), Copper (Cu), Aluminum (Al) or an alloy of two or more materials selected from silver (Ag), Copper (Cu), Aluminum (Al). Further, the metal layer 60 may also be formed by metal of which the conductivity is 60% or more of the conductivity of silver (Ag). However, the material for the metal layer 60 may not be limited to the above materials.

The protective, metal, and frit layers 50, 60, and 70, respectively, may be formed on the first substrate 10 and/or the second substrate 20, e.g., on the first sealing line SL10 and/or on the second sealing line SL20. For example, if the protective, metal, and frit layers 50, 60, and 70, respectively, are formed on both the first and second substrates 10 and 20, the heating/sealing process ST50 may heat the metal layer 60, i.e., both first and second metal layers 61 and 62, via an induced current to melt the first and second frit layers 71 and 72, so the first and second substrates 10 and 20 may be pressed to each other via the frit layer 70 to form a seal therebetween, as illustrated in FIG. 10. Each of the processes ST10-ST50 will be described hereinafter in more detail with reference to the accompanying figures.

Referring to FIGS. 6 and 9-10, the protective layer forming process ST10 may include forming the protective layer 50, e.g., forming the first protective layer 51 on the first substrate 10 and/or forming the second protective layer 52 on the second substrate 20. The protective layer 50 may be on the sealing line SL, so the first and second protective layers 51 and 52 may be formed on respective inner surfaces of the first and second substrates 10 and 20 to face one another. In this respect, it is noted that an “inner surface” of, e.g., a substrate, refers to a surface facing the discharge cells 27.

The protective layer 50 may have, e.g., a band shape having a predetermined width, as illustrated with respect to the first protective layer 51 in FIG. 6. The predetermined width of the protective layer 50 may be measured, e.g., as a width along the y-axis of a longitudinal portion of the first protective layer 51 positioned on the first sealing line SL 1O. The widths of the longitudinal portions of the protective layer 50 may be substantially the same as widths of the shorter portions of the protective layer 50, i.e., portions along the second sealing line SL20. For example, the protective layer 50 may be a continuous layer having a closed-shaped cross-section. An outermost edge of the protective layer 50, e.g., an outermost edge of the first protective layer 51 along the x-axis, maybe coextensive, with an edge of the first substrate 10, e.g., substantially coplanar in the xz-plane.

The protective layer 50 may be formed of a heat insulating material and/or a shock-absorbing material, and may be positioned between the metal layer 60 and a respective substrate. Accordingly, the protective layer 50 may block or substantially minimize heat transfer from the metal layer 60 to the first and second substrates 10 and 20 during the sealing process, e.g., the first protective layer 51 may block heat transfer to the first substrate 10. Further, if the protective layer 50 is formed of a shock-absorbing material, the protective layer 50 may absorb sealing impact. The first protective layer 51 may protect four sides of the rear substrate 10 from heat and impact. The protective layer 50 may be formed of a different material than the metal layer 60.

Referring to FIGS. 7 and 9-10, the metal layer 60 may be formed on the protective layer 50, e.g., first and/or second metal layers 61 and 62 may be formed on respective first and/or second protective layers 51 and 52. For example, the metal layer forming process may form the first metal layer 61 on the first protective layer 51, and may form the second metal layer 62 on the second protective layer 52 to face the first metal layer 61. The metal layer 60 may be heated by an induced current, and may generate heat during the sealing process as a result of the electrical current generated therein. For example, the metal layer 60 may generate heat along four sides of the first substrate 10.

The metal layer 60 may have, e.g., a band shape having a predetermined width, as illustrated with respect to the first metal layer 61 in FIG. 7. It is noted, however, that a continuous band may not be required, and the metal layer 60 may include, e.g., a plurality of discrete segments arranged in a band shape. The predetermined width of the metal layer 60 may be measured, e.g., as a width along the y-axis of a longitudinal portion of the first metal layer 61 positioned on the first sealing line SL10. A width of the metal layer 60, e.g., a width of a longitudinal portion of the first metal layer 61 along the y-axis, may be smaller than a corresponding width of the protective layer 50, so a portion of an inner surface of the protective layer 50 may be exposed. In this case, heat generated from the metal layer 60 may be effectively blocked by the protective layer 50, so the impact of the sealing process may be absorbed by the protective layer 50 without substantially affecting the first and second substrates 10 and 20 and/or internal elements therebetween.

Referring to FIGS. 8-10, the frit layer 70 may be formed on the metal layer 60, e.g., first and/or second frit layers 71 and 72 may be formed on respective first and/or second metal layers 61 and 62. For example, the frit layer forming process may form the first frit layer 71 on the first metal layer 61, and may form the second frit layer 72 on the second metal layer 62 to face the first frit layer 71. For example, the frit layer 70 may have a substantially same shape, e.g., a substantially same cross section in the xy-plane, as the metal layer 60 and the protective layer 50. A width of the frit layer 70, e.g., a width of a longitudinal portion of the first frit layer 71 along the y-axis, may be smaller than a corresponding width of the metal layer 60, as illustrated in FIG. 8, so a portion of an inner surface of the metal layer 60 may be exposed.

Referring to FIG. 9, which illustrates a cross-sectional view of the alignment process ST40 before sealing of the first and second substrates 10 and 20 of FIG. 5, the alignment process ST40 may align the first and second substrates 10 and 20 after processes ST10-ST30 described previously with reference to FIGS. 6-8. For example, a separately formed electrode layer 30 may be interposed between the first and second substrates 10 and 20.

As illustrated in FIG. 9, the first and second substrates 10 and 20 may be aligned to form a symmetrical structure along a vertical direction, i.e., along the z-axis, and along a horizontal direction, i.e., along the x-axis. In other words, the alignment may be, e.g., vertically symmetric with respect to the electrode layer 30. For example, the first substrate 10, the first protective layer 51, the first metal layer 61, the first frit layer 71, the electrode layer 30, the second frit layer 72, the second metal layer 62, the second protective layer 52, and the second substrate 20 may be sequentially disposed from bottom to top.

FIG. 10 illustrates a cross-sectional view of a process for sealing the first and second substrates 10 and 20 by heating the metal layer 60 with an induced current generated from an induced current generator, i.e., an inductor. Referring to FIG. 10, the heating/sealing process ST50 may heat the metal layer 60 by using induced currents generated by equipment such as an induced current generator 80, e.g., first and second current generators 81 and 82. It is noted that the shape of the inductor coils, the position thereof relative to the PDP, the driving frequency of the inductor, etc. may be determined based on the design, e.g., shape and materials, of the PDP.

The current generator 80 may be positioned proximate and along outer surfaces of the first and second substrates 10 and 20, i.e., surfaces facing away from the electrode layer 30, and may have a shape corresponding to a shape of the metal layer 60, e.g., a band shape having a predetermined width or a square brim shape corresponding to the sealing line SL. The first and second current generators 81 and 82 may be disposed proximate to the first and second substrates 10 and 20, respectively. For example, the first and second current generators 81 and 82 may overlap the first and second metal layers 61 and 62, respectively.

Electrical currents induced in the metal layer 60 by alternating magnetic fields from the current generator 80 may heat the metal layer 60 through self-heating, i.e., joule heating, at portions corresponding to the sealing line SL, so the frit layer 70 in contact with the metal layer 60 may soften or melt. For example, the first induced current generator 81 may heat the first metal layer 61 corresponding to the first sealing line SL10 of the first substrate 10, and the second induced current generator 82 may heat the second metal layer 62 corresponding to the second sealing line SL20 of the second substrate 20. The first metal layer 61 may transmit the heat to the first frit layer 71, and the second metal layer 62 may transmit the heat to the second frit layer 72. In other words, the first and second current generators 81 and 82 may provide heat to respective first and second frit layers 71 and 72 via respective metal layers 61 and 62 to impart fluidity to the first and second frit layers 71 and 72. Accordingly, heat for sealing the first and second substrates 10 and 20 may be applied to the frit layer 70 by applying heat to the metal layer 60 via the current generator 80, so application of heat may be controlled to be localized, e.g., selectively applying heat only to the frit layer 70, thereby minimizing heat effects on other portions of the PDP. Further, during the heating/sealing process ST50, the protective layer 50 may prevent heat and impact from being transmitted to the first and second substrates 10 and 20. Thus, the first and second frit layers 71 and 72 may be melted or softened to a relatively fluid state, and may be adhered and pressed toward each other to combine into a single frit layer sealing the first and second substrates 10 and 20 with each other.

The single frit layer may be positioned in the non-display area of the PDP, and may fill, e.g., completely fill, a space between the first and second substrates 10 and 20 in peripheral regions of the PDP to surround, e.g., completely surround, the connection units 35, as illustrated in FIG. 10. Accordingly, edges of the first and second electrodes 31 and 32 in the electrode layer 30 may extend from the display area through the frit layer 70 to define the connection units 35 in the non-display area of the PDP. In other words, the electrode layer 30 may be drawn outside the sealing line SL to define a plurality of connection units 35 external to the display area of the PDP, so the frit layer 70 on the sealing line SL may surround the connection units, as illustrated in FIG. 10.

For example, when the electrode layer 30 is formed by anodizing, the connection units 35 may respectively include conductive unit 135 and a dielectric layer 235 on the conductive unit, e.g., an oxide layer surrounding the conductive unit, to be positioned between the conductive unit 135 and the frit layer 70. The conductive unit 135 may be formed, e.g., of aluminum (Al), and the oxide layer 235 may be formed of, e.g., aluminum oxide (Al₂O₃), deposited on a surface of the conductive unit 135. The conductive unit 135 may be electrically isolated from the meal layer 60 by the frit layer 70 and/or the dielectric layer 235.

According to an example embodiment, a PDP may include metal and frit layers on a sealing line between first and second substrates, so the metal layer may be heated by an induced current to transfer heat to the frit layer. The frit layer may be melted by the heat transferred from the metal layer, e.g., to exhibit fluid characteristics, so the melted frit layer may bond, i.e., seal, the first and second substrates to each other along the sealing line. Sealing of the first and second substrates via induced current in the metal layer may facilitate controlled heating of a predetermined area between the first and second substrates, e.g., heating only the frit layer, so overall deformation of the substrates may be prevented or substantially minimized. Further, deformation of internal elements, e.g., electrodes in a display area between the first and second substrates, may be minimized.

The PDP may further include a protective layer between the metal layer and a corresponding substrate, so heat may not be transferred from the metal layer to the substrates. Further, the protective layer may absorb compression impact so deformation of the substrates and the internal elements of the substrates may be prevented.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate and a second substrate overlapping each other, the first and second substrates being sealed with each other along a sealing line, the sealing line being in peripheral portions of the first and second substrates;
a metal layer along the sealing line on at least one of the first and second substrates, the metal layer being between the first and second substrates; and
a frit layer on the metal layer.

2. The PDP as claimed in claim 1, further comprising a protective layer along the sealing line on at least one of the first and second substrates, the protective layer being between the metal layer and a corresponding substrate.

3. The PDP as claimed in claim 2, wherein the protective layer has a band shape with a predetermined width along the sealing line.

4. The PDP as claimed in claim 1, wherein the metal layer has a band shape with a predetermined width along the sealing line.

5. The PDP as claimed in claim 4, wherein the frit layer has a band shape with a predetermined width along the metal layer.

6. The PDP as claimed in claim 2, wherein the protective layer includes a heat insulating material and/or a shock absorbing material.

7. The PDP as claimed in claim 2, wherein the protective layer includes a first protective layer on an inner surface of the first substrate and a second protective layer on an inner surface of the second substrate, the first and second protective layers facing each other.

8. The PDP as claimed in claim 7, wherein the metal layer includes a first metal layer on the first protective layer and a second metal layer on the second protective layer, the first and second metal layers facing each other.

9. The PDP as claimed in claim 8, wherein the frit layer is between the first and second metal layers.

10. The PDP as claimed in claim 2, further comprising a plurality of electrodes between the first and second substrates, the electrodes including connection units extending through the frit layer, the connection units being surrounded by the frit layer on the sealing line and electrically isolated form the metal layer.

11. The PDP as claimed in claim 10, wherein a portion of the connection unit in the frit layer includes a conductive unit surrounded by a dielectric layer.

12. A plasma display panel (PDP) manufacturing method, comprising:
forming a first substrate and a second substrate to overlap each other and to seal with each other along a sealing line, the sealing line being in peripheral portions of the first and second substrates;
forming a metal layer along the sealing line on at least one of the first and second substrates, the metal layer being between the first and second substrates; and
forming a frit layer on the metal layer.

13. The PDP manufacturing method as claimed in claim 12, further comprising:
inducing current in the metal layer using an inductor disposed proximate to the PDP, such that the metal layer is heated;
pressing the first and second substrates toward each other, such that the first and second substrates are sealed together via the frit layer.

14. The PDP manufacturing method as claimed in claim 12, wherein the metal layer is formed in a band shape having a predetermined width along the protective layer.

15. The PDP manufacturing method as claimed in claim 14, wherein the frit layer is formed in a band shape having a predetermined width along the metal layer.

16. The PDP manufacturing method as claimed in claim 12, further comprising forming a protective layer along the sealing line on at least one of the first and second substrates, the protective layer being between the metal layer and a corresponding substrate.

17. The PDP manufacturing method as claimed in claim 16, wherein the protective layer is formed in a band shape having a predetermined width along the sealing line.

18. The PDP manufacturing method as claimed in claim 16, wherein forming the protective includes forming a first protective layer on an inner surface of the first substrate and a second protective layer on an inner surface of the second substrate, such that the first and second protective layers face each other.

19. The PDP manufacturing method as claimed in claim 18, wherein forming the metal layer includes forming a first metal layer on the first protective layer and a second metal layer on the second protective layer, the first and second metal layers facing each other.

20. The PDP manufacturing method as claimed in claim 19, wherein forming the frit layer includes forming a first frit layer on the first metal layer and a second frit layer on the second metal layer, the first and second frit layers facing each other.
